(19) United States
(12) Patent Application Publication
(10) Pub. No.: US 2005/0177489 A1
(43) Pub. Date: Aug. 11, 2005

(54) Method for licensed lender disbursement of loan proceeds to an out-of-state borrower to establish with greater certainty that the law of the state in which the licensed lender is located is the state law which governs the loan transaction

(75) Inventors: Wheeler Neff, Wilmington, DE (US); David S. Wiggins, Christiansted, VI (US)

Correspondence Address: CONNOLLY BOVE LODGE & HUTZ, LLP, P O BOX 2207, WILMINGTON, DE, 19899, US

(73) Assignee: National Title Loans, Inc.

(21) Appl. No.: 10/775,578

(22) Filed: Feb. 9, 2004

(51) Int. Cl. G06F 17/60

(52) U.S. Cl. 705/38

(57) ABSTRACT

A method for disbursing loan proceeds, which has the following steps: (a) a borrower residing in a different jurisdiction from the location of a licensed lender contacting said lender about obtaining a loan; (b) said licensed lender forwarding the application to said borrower; (c) said borrower transmitting the executed loan application and requested documentation to said licensed lender; (d) said licensed lender accepting and processing the loan application; (e) said licensed lender approving the loan application; (f) said licensed lender pursuant to authorization of borrower automatically opening an account for said borrower at a banking institution located in the same state jurisdiction as such licensed lender and its banking institution; (g) said licensed lender disbursing the loan proceeds from its funding account at its banking institution to said borrower's newly created bank account; (h) such loan proceeds then being automatically wired from said borrower's new bank account at said banking institution in the same state jurisdiction as such the licensed lender and its banking institution to a bank checking account of said borrower in a different state jurisdiction where said borrower currently banks; (i) and, said licensed payday lender, pursuant to a pre-authorization by borrower, arranging repayment of such loan through the Federal Reserve to debit the loan amount and accrued interest and fees from said bank account of borrower in his/her home state jurisdiction by having such money wired to the bank account of the licensed lender at such licensed lender's banking institution.

### FIELD OF THE INVENTION

The present invention relates to a method or process of disbursement of consumer loan proceeds to borrowers residing in a state or country different from the location of the licensed lender in a way that makes more certain that the law applicable to such loan transactions will be the law of the state in which the licensed lender is located. A licensed lender is a financial services entity licensed by its state banking regulator to make loans primarily to individual consumers. More particularly, the process involves the disbursement of loan proceeds by a licensed lender to a newly created bank account of an out-of-state borrower (or international borrower from another country), which is automatically established by the licensed lender for such borrower at a banking institution in the same state in which the licensed lender is located.

Determining Applicable Law:

Because disparate conflicts of law rules make uncertain as to which state's laws apply in interstate loan transactions when the Borrower is in one state and the Lender is in another, the establishment of such a bank account enables the licensed lender to fix with greater certainty the state jurisdiction and law governing the loan transaction. By having virtually all of the elements of the loan transaction performance, including the delivery and receipt of loan proceeds occur in the state where the licensed lender is located, it is more certain that the law applicable to such loan transaction will be that of the licensed lender's location state. The applicable law of such state jurisdiction affects the terms controlling the loan transaction including the interest rate or fees that can be charged, rollover or renewal terms that can be provided, and the remedies that are available to the licensed lender if there is a default by the borrower. The consumer loans are short term loans and include but are not limited to payday and title loans. The loans can also be home equity loans. For reference purposes only, the background discussion below will focus on two of the most common short term loans, payday and title loans.

### BACKGROUND OF THE INVENTION

There is a large and growing market demand in the United States for short-term, emergency consumer loans among a large segment of the U.S. population neglected by traditional banking institutions.

Payday Loans

With respect to just the payday loan industry itself, payday loan outlets that offer such types of loans have grown from virtually 0 in 1990 to over 10,000 loan offices in 1999 (Payday Advance Credit in America: An analysis of customer demand, April 2001, Monograph #25, Gregory Elliehausen, Ph.D. and Edward C. Lawrence, Ph.D., Credit Research Center, McDonough School of Business, Georgetown University, Washington, D.C. p.2 (“Payday Advance Credit”). Such short-term emergency loans (commonly referred to as “payday” loans since they are usually repaid by the borrower at the time of his/her next payday) are most often used by such borrowers to meet temporary, cash flow emergencies (Payday Advance Credit p. 55) They are designed to mature and be repaid on the borrower's next payday and have become increasingly popular among adult persons having moderate family incomes between $25,000-$49,999 which comprise approximately 51% of the U.S. adult population (Payday Advance Credit p. 55). Over 91% of payday loan borrowers find such payday loans to be helpful in meeting their economic and financial needs (Payday Advance Credit p. 35).

Title Loans:

Similar in purpose to payday loans in terms of meeting consumer's periodic financial/cash flow emergencies, title loans have also emerged as an increasingly popular form of consumer loan. Title loans differ from payday loans in that they are secured by the title of the Borrower's motor vehicle, but are similar to payday loans in that they are also short term (30-60 days) with the option of roll-overs for additional 30 day periods. Similar to payday borrowers demographically, title loan borrowers tend to range in age from 35 to 43 years old, have stable residences (over 80% at same residence between two and ten years) and have mainstream income with over 60% of title loan borrowers having annual income between $30,000 and $75,000+ with the largest segment having income between $50,000 and $74,999. Title Loan—Demographic Profiles: R L Polk Company, Jan. 12 2000, pp. 2-5.

Original Secured Short-Term Consumer Loans:

Prior to the arrival of payday and title loans within the last ten years, cash flow emergency needs among that moderate income group were often met through secured consumer loans involving the placement of valuables with a pawnbroker since unsecured credit card borrowing was not made available to such moderate income borrowers by main stream banks. The pawnbroker would advance money to the borrower based on certain valuables which were placed with the pawnbroker as collateral. The borrower then had a certain period of time during which he or she must repay the loan, along with a handling fee and interest, or the valuables would become the property of the pawnbroker and ultimately sold to recoup the money loaned. While using a pawnbroker may be convenient at times, the person needing the emergency loan may not have valuables to pawn, or may not want to go through the processes of pawning goods which he or she wishes to later reclaim. It also may be inconvenient in that such type of secured lending involves face-to-face contact between the borrower and pawnbroker. Thus, many people needing emergency loans would prefer not to use a pawnbroker if there were an alternative credit facility available that can provide virtually instant cash in a convenient, cost effective way. Not surprisingly, such alternative credit facilities (payday and title loans) that conveniently meet consumers financial needs has grown exponentially over the last several years and has now evolved into a major segment of the over-all consumer loan industry.

Types of Payday Loans:

One common type of payday loan involves a borrower who provides the payday lender with a post-dated check for the amount of loan principal plus anticipated interest in exchange for immediate cash from the lender. The check is typically post-dated for the day after the borrower will receive his or her next paycheck, usually two weeks or so from the date of the loan application. The borrower is given cash in person on the spot after certain minimum identification and underwriting criteria are met. While this is often extremely timely for the borrower, it raises significant security issues. The licensed payday lender must typically have bulletproof glass and other security measures to protect its workers and the large amount of cash kept on hand. Additionally, the borrower must be careful because of the attendant risks of receiving and carrying several hundred dollars in cash out into the street.

With other types of payday loans, the borrower is given the loan proceeds in the form of a check that can be cashed at either the borrower's bank or a check-cashing outlet. The borrower is then able to use the loan proceeds for whatever urgent financial needs exist. In most of the above-referenced disbursement scenarios (cash or check), the licensed payday lender will be repaid the principal and interest when the borrower's post-dated check is cashed by the lender several weeks later upon maturity of the loan, usually at the time of the borrower's next payday. However, as with the pawnbroker scenario, the cash or check process may not be convenient for the borrower since both require proximity to the licensed payday lender and face-to-face contact if the loan proceeds are to be provided to the borrower quickly in cash.

New Interstate Payday Loans:

Recently, a few licensed payday lenders have begun offering payday loan services over the Internet to borrowers located in states throughout the United States. In such instances, applicants respond to the Internet advertising by submitting application information regarding his or her need for a payday loan, the desired loan amount, checking account number, employment status, and other relevant identifying information. Upon approval, the loan proceeds are then wired to the borrower's home state bank checking account and are available the same or next day for use. Such a system has the advantage of not requiring the individual to have proximity or face-to-face contact with the licensed payday lender in order to obtain needed funds. This is highly desirable because borrowers get immediate access to those funds and avoid the risk, time and trouble of picking up cash or cashing a loan check. In some communities, the nearest licensed payday lender may be a considerable distance away in another state and may have inconvenient hours of operation. However, a major drawback of this process involving interstate payday loan transactions in which the licensed lender and borrower are located in different states is that it is less than certain which state jurisdiction's laws control the loan transaction as discussed below.

Nevertheless, payday and title loans have become increasingly popular for those facing an immediate cash flow crunch. Payday loans allow borrowers to meet financial emergencies such as mandatory mortgage or rent payments, or minimum monthly credit card payments before such loans go delinquent and a late charge (typically $25-$30) is incurred or a bad check charge (typically $20-$40) is imposed. The expense associated with obtaining such short-term consumer loans is often less than the series of the late payment and non-sufficient funds (“NSF”) charges which would be incurred if monthly mortgage payments are late or bad checks are issued. And because such short-term loans are actually made to cover the financial emergency, there are no adverse credit events (late or missed payments) or bad checks on the part of the borrower to be reported to credit reporting agencies thus further eroding such borrower's credit rating. Moreover, the repayment of the principal and interest payment can be deferred for several weeks until after receipt by the borrower of his/her next paycheck in the case of either payday or title loans. In other types of non-financial emergency situations, such short-term consumer loans may be advanced simply to allow the person to make a purchase of an item, which is currently available at a reduced price, which justifies paying the interest fee for a short-term loan. This includes some items, which are sold on a cash only basis. Thus, the borrower is able to save money by making the purchase during a low sale price or take advantage of a one-time liquidation opportunity.

Interstate Title Loans:

Likewise, title loans are also being offered interstate via the Internet to Borrowers residing in different states. In such instances, consumers respond to interstate advertising appearing in various print and broadcast media, as well as the Internet by downloading various application materials for a title loan and filling out the application forms and faxing them along with requested identifying documentation e.g. driver's licenses, etc., along with a copy of the clear title to a motor vehicle to a title lender. Upon receipt and approval of such application materials, the licensed lender will mail the loan proceeds check or direct deposit the loan proceeds in the Borrower's checking account at his/her home state bank. However, as with interstate payday loans, a major drawback of this process involving interstate title loan transactions in which the licensed lender and borrower are located in different states is that it is less than certain which state jurisdiction's laws control the loan transaction as discussed below.

Determining Applicable Law:

In the case of licensed lenders making loans interstate using the Internet where certain elements of the loan transactions occur in both the state where the licensed lender is located and the state of residence of the borrower, it is less than certain which state law applies to the transaction. Many factors need to be considered to determine which state has the most “significant relationship” to the loan transaction and/or parties to the transaction to establish which state's laws apply. Such “significant relationship” is predicated on a number of important factors or elements that are part of the loan process, including the following:
(1) Does the loan agreement explicitly provide which state's law governs the transaction? Ideally, the payday loan agreement should have an express provision provide that the loan transaction is governed by the law of the state in which the licensed lender is located.
(2) In addition, in what state does the most essential, material elements of the loan transaction such as the following take place? Such essential elements include:
   (1) The state of incorporation/domicile of the parties to the transaction.
   (2) The state in which the transaction is formally agreed to (the state in which the fully executed agreements and requested documents, that form the basis for approval, are received by the lender).
   (3) The state in which the loan application is processed and the credit approval decision is made on the loan application by the lender.
   (4) The state in which performance of the loan transaction occurs i.e. issuance of the loan proceeds by the licensed lender and receipt of the loan proceeds by the borrower.
   (5) The state in which most of the other elements of the loan program take place (loan product development, establishment of licensed lender's credit criteria, marketing, wiring of funds and receipt of repayment by borrower).

Thus, there is a need for a method or process by which an out-of-state or out of the country borrower can obtain loan proceeds from a licensed lender in a way that combines convenience and safety to the borrower, and greater certainty that the law applicable to the loan transaction is the law of the state in which the licensed lender is located. For that to happen, virtually all of the essential elements of the loan transaction including the receipt of the disbursed loan proceeds by the borrower must take place in the state where the lender is located.

### SUMMARY OF THE INVENTION

Thus, it is an object of the present invention to provide an improved method of disbursing consumer loan proceeds to out-of-state borrowers in a way that enables the licensed lender to select with more certainty the desired state jurisdiction by structuring the loan transaction in such a way as to have the most significant factors/elements of the loan transaction (especially all material aspects of performance i.e. loan disbursement, receipt of loan proceeds and receipt of loan repayments) occur in the selected state of location of the lender to take advantage of the favorable laws of such state jurisdiction relating to permissible interest rates, more flexible lending laws, etc. Some jurisdictions such as Delaware permit licensed lenders to impose more flexible or higher rates and fees, and more accommodating operating terms for payday loans.

The above and other aspects of the present invention are achieved in a method for disbursing short-term consumer loan proceeds such as title loan or payday loan proceeds. Short-term loans are loans generally less than about 5 years, preferably less than about 1 year, more preferably about 1 month or less, and most preferably about 2-3 weeks or less. Although, this method will work for any loan (short or long term), it will be utilized more for short-term loans.

a. Consumer Loan Process:

The short-term consumer loan process of licensed lenders is as follows: Borrower responds to interstate media or Internet advertising by completing a loan application which the applicant transmits electronically by fax to the licensed lender with the appropriate requested supporting documentation including copies of pay stubs, driver's licenses, checking account information, etc. In the case of a title loan, the lender also requests the title of the collateral being used (such as an automobile, boat, house etc.) The licensed lender also obtains information from the applicant that is necessary to process a loan such as certain minimal credit information. The loan application is then processed by the licensed lender.

b. Unique New Deposit Account Feature of Consumer Loan Process:

Upon approval of the loan, the licensed lender is authorized to automatically open a bank account for the out-of-state or out-of-the country borrower at a bank in the same state jurisdiction that the licensed lender and its banking institution are located and to deposit the loan proceeds into such newly created bank account. Such borrower's new bank account may be with the same banking institution used by the licensed lender for its funding account or a different banking institution. The funds are transferred from the licensed lender's funding account at its banking institution to the newly created bank account of the out-of-state or out-of-country borrower. These funds are then transferred by wire from the borrower's new account at the banking institution in the same jurisdiction as the lender and its banking institution to the borrower's checking account at another banking institution in the borrower's home state or the state the borrower banks in. Banking institution in the borrower's home state will be referred throughout the application. This term includes banks in the borrower's home state or the state the borrower works in or the state the borrower banks in. Most of the time, the borrower works, resides and banks in the same state.

Notwithstanding the creation of the borrower's new bank account, the out-of-state or out-of-country borrower has in nearly all cases, same day access to the loan proceeds as of the date of disbursement of the loan by the licensed lender.

At the option of the out-of-state or out-of-country borrower, such borrower's new bank account may be automatically closed immediately after the loan proceeds are wired out from such new account to the borrower's existing home state bank checking account or closed after a set period such as but not limited to ninety days. This period can be extended as many times as desired, especially if the borrower continually applies for additional loans. Thus, the borrower's new bank account could be a single transaction account created for the sole purpose of receiving the loan proceeds of a single loan transaction which account would close automatically after such proceeds are received and wired out, or such account could remain open for a predetermined period of time even after all the funds have been wired out so that additional, future loans, such as payday or title loans, can be received in such account by such out-of-state borrower from the licensed lender. Therefore, in accordance with another aspect of the present invention, subsequent loans to such out-of-state borrower may be made in response to a request of a borrower (by telephone, on-line with a computer, fax etc.) using the same loan disbursement process as described above. Some of the information may not be required, because the lender has the information from the previous application.

c. Competitive Advantage of Unique Bank Account:

A competitive advantage of this invention is that the licensed lender is able to be more certain of which law is applicable to the interstate loan transaction and thus the licensed lender is able to increase his or her market share of borrowers by marketing to out-of-state or out of the country borrowers via the Internet or other media advertising while centralizing and consolidating its loan processing operations in a single licensed location. This is particularly advantageous for a licensed lender which has located in a state that has consumer loan laws that are most compatible with the operating requirements to the licensed lender to enable it to be profitable.

The invention relates to a method for disbursing a loan which comprises the following steps:
(a) a borrower not residing in the same state as the location of a licensed lender contacting such licensed lender about obtaining a loan;
(b) said licensed lender forwarding the application to said borrower for completion;
(c) said borrower transmitting the executed loan application and requested documentation to said licensed lender;
(d) said licensed lender accepting and processing the loan application;
(e) said licensed lender approving the loan application;
(f) said licensed lender pursuant to authorization of borrower automatically opening an account for said borrower at a banking institution located in the same state jurisdiction as such licensed lender and its banking institution;
(g) said licensed lender disbursing the loan proceeds from its funding account at its banking institution to said borrower's newly and automatically created bank account which would receive the disbursed loan proceeds; and
(h) such loan proceeds then being automatically wired from said borrower's new bank account at said banking institution in the same state jurisdiction as such licensed lender and its banking institution to the bank checking account of said borrower located in a different state jurisdiction where said borrower resides and currently banks, and
(i) said licensed lender, pursuant to a pre-authorization by borrower, arranging repayment of such payday loan through the Federal Reserve to debit the loan amount and accrued interest and fees from said bank account of borrower in his/her home state jurisdiction or international jurisdiction and having such money wired to the bank account of the licensed lender at such licensed lender's banking institution.

### BRIEF DESCRIPTION OF THE DRAWINGS

The above and other objects, features and advantages of the invention will become apparent from a consideration of the following detailed description presented in connection with the accompanying drawings in which:

FIG. 1 shows a schematic representation of the method of the present invention.

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the pending claims.

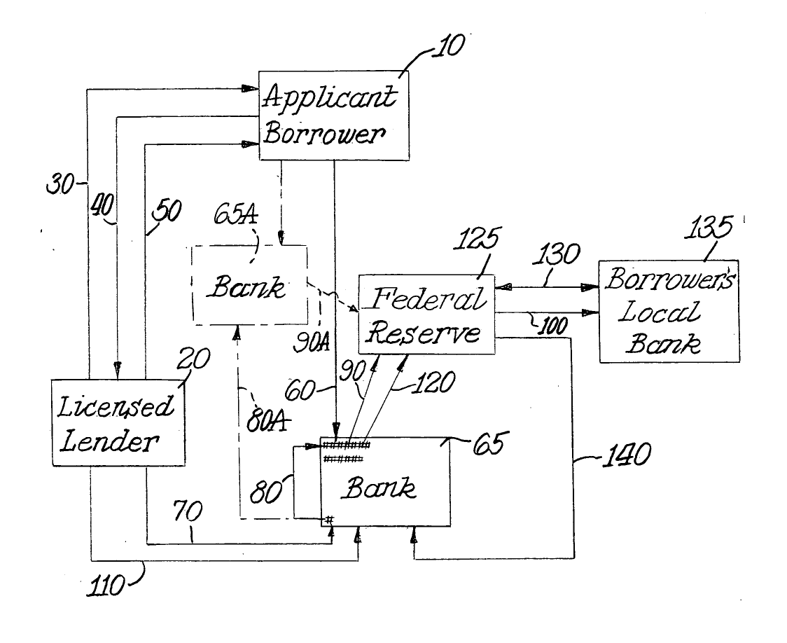

Referring to FIG. 1, there is shown a schematic view representing a method of disbursing a loan in accordance with the principles of the present invention. The lending institution 20 located in a desired region, preferably a state or territory of the United States, such as Alabama, Alaska, Arizona, Arkansas, California, Colorado, Connecticut, Delaware, Florida, Georgia, Hawaii, Idaho, Illinois, Indiana, Iowa, Kansas, Kentucky, Louisiana, Maine, Maryland, Massachusetts, Michigan, Minnesota, Mississippi, Missouri, Montana, Nebraska, Nevada, New Hampshire, New Jersey, New Mexico, New York, North Carolina, North Dakota, Ohio, Oklahoma, Oregon, Pennsylvania, Rhode Island, South Carolina, South Dakota, Tennessee, Texas, Utah, Vermont, Virginia, Washington, West Virginia, Wisconsin, Wyoming, Washington D.C., U.S. Virgin Islands, Puerto Rico and other territories of the United States. It is also possible that the lending institution can be located in a region outside the United States in another country, such as, but not limited to Japan; China; Australia; India, Pakistan, Germany, England, France, Spain, Italy, Austria, Belgium, Switzerland; etc.

For simplicity, throughout the application, the applicants may refer to Delaware, but it is clear that any region, or U.S. state or territory can apply. In addition, the term out-of-state used below equally applies to out-of-country.

The licensed lender 20 advertises 30 in interstate, intrastate or international print media (newspapers, yellow pages, television, radio etc.) and via the Internet as a provider of loans, preferably short-term loans made quickly to meet immediate financial emergencies of borrowers.

The applicant 10 applies to the licensed lender 20 for such loans, via faxed applications 40 sent to the licensed lender located in a certain state such as, but not limited to, Delaware. Once the out-of-state applicant 10 has selected the type of loan (such as, but not limited to payday, title or home equity loans) and the term and amount desired, the licensed lender may obtain certain identification information regarding the applicant. In particular, the licensed lender may verify the identity of the applicant; verify the income of the applicant; and verify the income of bank account of the out-of-state applicant usually in his/her home state or the state where he/she banks. Such verification may be accomplished by having the applicant scan his/her driver's license, most recent pay stub and voided check on a scanner and then transmit the scans by telefax or e-mail to the licensed lender. If a title loan is desired, the lender may obtain the original title of the collateral desired to be used to obtain the loan.

The licensed lender can then verify that the applicant is able to repay the loan and ensure that the applicant does not have other payday loans already outstanding secured by the next salary or wage payment. This will typically be accomplished by a transmitter or telephone line relaying the information to a central processing center specializing in payday loan borrowers at which there is verification of the information.

Once the out-of-state applicant's information has been verified and the applicant approved for the loan, loan documents are generated by the licensed lender for execution by the applicant. The loan documents can be e-mailed to such applicant or accessed on line where a digital copy of the loan document can be produced on a screen which can receive the customer's signature, as an alternative to a manually signed copy which is faxed to the lender.

The loan agreement will specify which state law applies. For example, if the licensed lender is in Delaware, the terms of the loan agreement will specify that the laws of Delaware apply to the terms of the loan. Because the loan application can be completed and returned to the lender by transmission means, the out-of-state borrower 10 is not required to go to the offices of the licensed lender 20 to provide the documentation associated with obtaining the loan. With respect to payday loans, the functional equivalent of the post-dated check can be created pursuant the Uniform Commercial Code, Title 1, Section 1-201 (39) and Title 3, Sections 3-104, 3-401 and 3-403, Code of Federal Regulations, Title 12 Chapter II, Part 210 and Regulation J. Federal Reserve Bank, Part 2, Sections 4a-201 to 4a-212.

In addition to providing identifying information to the licensed lender 20 regarding the out-of-state borrower, information is also provided by the borrower as to how promptly the borrower 10 needs the money. Thus, for example, if the out-of-state borrower 10 needs the funds that day or the next business day, the borrower may select one price option which allows the lender 20 to send the funds to the newly created bank account of such borrower from which in turn funds are wired into his or her checking account at the local bank or credit union 135 in the borrower's home state. Those of skill in the art will appreciate, in light of the present disclosure, that having funds directly deposited into the borrower's account will make those funds more readily available to such borrower 10.

Such applicant's loan applications are reviewed 50 by licensed lender personnel 20 and, if applicant has a satisfactory credit history, proper underwriting documentation and verified identification, the loan application will be approved by the licensed lender 20 in its desired state location, such as, but not limited to, Delaware. Approval is typically based on confirming that the out-of-state applicant is currently employed and that the next salary or wage payment will be sufficient to cover the amount of loan being advanced and accompanying charges.

As part of loan application process, if the loan application is approved by the licensed payday lender 20, the approved out-of-state borrower 10 automatically authorizes the licensed lender to open a bank account 60 at a banking institution 65 or 65A in the same state jurisdiction as the location of the licensed lender and its banking institution. The account can be at the same banking institution 65 that the licensed lender is using or a different banking institution 65A in the same state jurisdiction) shown in phantom. The application will refer to the banking institution as being the same as the licensed lender's banking institution although it can be a different one in the same state jurisdiction. The procedure will still be the same for receiving the funds and transferring the funds to such borrower's home state banking institution 135 as discussed below. The banking institution 65 in which such borrower's new bank account is automatically created to first receive the loan proceeds can be any financial institution legally authorized to take deposits provided it is located in the same state as the licensed lender making such loan. Such bank account is in the borrower's name to receive the loan proceeds.

At desired intervals, such as, but not limited to four times a day, three times a day, two times a day or once a day or even every other day, the licensed lender 20 creates a file for each approved borrower 10. The file indicates how much money is to be transferred to each borrower. The licensed lender 20 transmits 70 such file to its banking institution 65 in its home state such as Delaware. The file sent by the licensed lender can contain one name or multiple borrower names. The number of names in the file being transmitted depends on the number of loans approved and processed and the requirements of the licensed lender's banking institution 65. The file can be transmitted by e-mail or fax or downloaded from the Internet. The lender can place the file in a secured website and give its banking institution 65 access to the secured website so that such banking institution can download the information when it is about to process the loan files for disbursement of loan proceeds from the licensed lender's funding account to the newly created bank account for each borrower.

The banking institution 65, such as a Delaware bank, transfers 80 loan proceeds for borrowers from licensed lender's funding account 65 (indicated in the figure by the #) to borrowers'newly created deposit accounts at the same banking institution 65 (indicated in the figure by the multiple #####) or 80A another banking institution 65A in the same state jurisdiction.

The banking institution 65 or 65A, such as the Delaware bank, transmits 90 the loan proceeds from such out-of-state borrower's new account at such Delaware bank or other banking institution in Delaware to the Federal Reserve System 125. The transmission is shown in a phantom line 90A from 65A to the Federal Reserve System. 125.

The Federal Reserve System Automated Clearing House's (ACH) then 125 transfers 100 the loan proceeds to borrower's bank account at borrower's designated bank or credit union 135, in the borrower's home state.

The Banking Institution 65 such as the Delaware Bank transmits 120 borrower's repayment files to the Federal Reserve 125.

The Federal Reserve 125 debits 130 the borrower's bank account at borrower's home state banking institution 135.

The Federal Reserve 125 credits 140 the debited amount to the licensed lender's account at its banking institution 65 to pay off the borrower's payday loan from such licensed payday lender 20.

The procedure is the same for title loans as it is for payday loans with the exception that the borrower 10 gives the title of the collateral used for the loan to the lender 20. If the borrower 10 defaults on the loan, the lender 20, has title in the collateral and can repossess the collateral and force a sale if the lender 20 does not get paid.

Upon deposit of the loan proceeds in the out-of-state borrower's home state bank checking account, such borrower may access his or her funds by ATM withdrawal or by writing a check. The licensed lender will then be repaid the amount of the loan plus interest and costs by either (1) depositing a post-dated check of borrower or (2) pursuant to a prior authorization to debit the borrower's home state checking account following his/her next direct deposit of a paycheck in his/her home state banking institution.

The steps of the method can be further used by the out-of-state borrower to purchase extensions or rollovers of the loan. Thus, for example, if such borrower does not wish to pay off the loan upon receipt of his or her next paycheck, the borrower may call or fax the licensed lender and obtain an extension or rollover of the loan. This may be accomplished in one of two ways. First, the extension could simply provide that the post-dated check not be cashed or secondly, there could be a provision that the pre-authorized draw from the borrower's home state checking account not be taken by the licensed lender for some additional period of time. In either such scenario, the borrower would pay for such an extension or rollover by submitting an additional check to the licensed lender or authorize an additional debit to cover the additional interest and costs of the extension or rollover.

Once the loan proceeds have been wired to the out-of-state borrower's home state banking institution 135, the borrower 10 may access those funds in a variety of ways. First, the borrower 10 may write a check for any portion of the loan funds. If the recipient of the check performs a merchant verification on the check, the banking institution will report that the funds are available for the check to clear and the borrower is able to proceed with the financial transaction.

A more common method of utilizing the loan funds, however, is for the out-of-state borrower to directly access the cash in his/her home state bank account by using an automated teller machine (“ATM”). The use of the ATM is particularly advantageous in that it allows the borrower to access the funds even if she or he is in a remote location, such as another state, or even another country. It is common for many banking institutions to place holds on funds or checks of individuals, especially those who have questionable credit. However, by depositing the loan proceeds by wire, those funds are immediately available for withdrawal by the borrower 10.

The loan disbursement process set forth with respect to FIG. 1 has multiple advantages for both the out-of-state borrower 10 and the licensed lender 20. The out-of-state borrower 10 is able to access loan funds without visiting the physical establishment of a licensed lender, which may be geographically remote from the borrower. Additionally, such borrower 10 is able to access funds from his or her home state bank checking account in a manner which will not raise any privacy concerns or indications that the borrower may be having financial difficulties. Finally, such borrower 10 is given the opportunity of using an ATM at virtually thousands of remote locations around the world.

Moreover, the licensed lender 20 may be able to reduce the number of office locations and thus operate more efficiently with greater profitability and potential savings for borrowers. By omitting multiple “store fronts” in different states, the licensed lender can save a considerable amount of overhead. Some licensed lenders may be located in undesirable parts of town, or in areas without ready access to banks. By utilizing the method of the present invention, such licensed lender 20 can be conveniently located in an office building in a central business district with ready access to banks and credit unions. Furthermore, by locating in a lender-friendly state in terms of consumer lending laws and by disbursing loan proceeds to a bank account of an out-of-state borrower at a banking institution located in the same state as the licensed lender, the licensed lender has greater certainty that the laws of the state jurisdiction in which the licensed lender is located will govern the loan transaction.

Another important feature is that the method of the present invention dramatically increases the effective geographic radius in which the licensed payday lender may operate. While a “store front” for a licensed payday lender using the check or cash loan disbursement approach may have a geographic radius of several miles, utilization of the method of the present invention enables the licensed lender to effectively and with more legal certainty serve out-of-state borrowers throughout the U.S. The licensed lender would locate in its desired state jurisdiction with its banking institution which may also be the same banking institution in which the out-of-state borrower's new bank account is established. A licensed lender 20 that disburses loan proceeds into newly created bank accounts of out-of-state borrowers at banking institutions in the same state as such lenders are located could issue and collect such loans in virtually any state in the United States or world wide. The out-of-state borrower 10 then need only find an ATM to have access to the loan proceeds as soon as they are wired to such borrower's home state bank checking account.

This is in sharp contrast to the former conventional method of licensed lenders disbursing loan checks or cash which the borrower must pick-up in person in order to have immediate access to funds for emergency use. Moreover because many licensed lenders will not accept out of state checks, a person from another state attempting to use a post-dated check repayment approach would be unable to consummate the transaction. The present invention, in contrast, allows almost immediate access to loan proceeds regardless of the state location of the borrower, while preserving the desired state jurisdiction of the licensed lender as the state with the law controlling the loan transaction.

The present invention may be embodied in other specific forms without departing from its spirit or essential characteristics. The described embodiments are to be considered in all respects only as illustrative and not restrictive. All changes which come within that meaning and range of equivalency of the claims are to be embraced within their scope. Thus there is disclosed an improved method for disbursing loan proceeds. Those skilled in the art will appreciate numerous modifications which can be made without departing from the scope and spirit of the present invention. The appended claims are intended to cover such modifications.

All the references described above are incorporated by reference in its entirety for all useful purposes.

1. A method of dispersing loan proceeds which comprises the following steps:
a) a borrower not residing in the same state as the location of a licensed lender, contacting said licensed lender about obtaining a loan;
(b) said licensed lender forwarding a loan application to said borrower;
(c) said borrower transmitting the executed loan application to said licensed lender;
(d) said licensed lender accepting and processing the loan application;
(e) said licensed lender approving the loan application;
(f) said licensed lender pursuant to authorization of borrower automatically opening an account for said borrower at a banking institution located in the same state jurisdiction as said licensed lender and said licensed lender's banking institution;
(g) said licensed lender disbursing the loan proceeds from its funding account at said licensed lender's banking institution to said borrower's newly created bank account;
(h) automatically wiring the loan proceeds from said borrower's new bank account at said banking institution in the same state jurisdiction as said licensed lender and said licensed lender's banking institution to a bank checking account of said borrower in a different state jurisdiction where said borrower resides or currently banks;
(i) and, said licensed lender, pursuant to a pre-authorization by borrower, arranging repayment of said loan.

2. The method as claimed in claim 1, wherein the loan is a payday loan.

3. The method as claimed in claim 1, wherein the loan is a title loan.

4. The method as claimed in claim 1, wherein the method further comprises verifying the identity of the borrower.

5. The method as claimed in claim 2, wherein said account for the out-of-state borrower is at the same banking institution as the licensed payday lender and its banking institution.

6. The method as claimed in claim 2, wherein said bank account for the out-of-state borrower is at a different banking institution than said lender's banking institution but in the same jurisdiction.

7. The method as claimed in claim 1, wherein the loan application specifies the state jurisdiction of the loan transaction as being the same as the state where the licensed lender and its banking institution are located.

8. The method as claimed in claim 1, wherein the method comprises receiving the loan application via a facsimile or e-mail or through the Internet.

9. The method of claim 1, receiving a request from the borrower for an extension or rollover of the repayment date, extending the date and charging the borrower an additional loan fee for the extension or rollover.

10. The method as claimed in claim 1, wherein the borrower is outside the United States and the loan is an international loan.

11. The method as claimed in claim 1, wherein the loan is a short-term loan for less than about 5 years.

12. The method as claimed in claim 2, wherein the loan is a short term loan for less than about one month.

13. The method as claimed in claim 1, wherein step (i) said arranging repayment of said loan is through the Federal Reserve to debit the loan amount and accrued interest and fees from said bank account of borrower in his/her home state jurisdiction by having such money wired to the bank account of the licensed lender at said licensed lender's banking institution.
